(19) United States
(12) Patent Application Publication
(10) Pub. No.: US 2026/0252902 A1
(43) Pub. Date: Aug. 27, 2026

(54) RETRIEVAL AUGMENTED GENERATION BASED FINE-TUNING OF MACHINE LEARNING MODELS

(71) Applicant: INTUIT INC., Mountain View, CA (US)

(72) Inventors: Natalie BAR ELIYAHU, Azor (IL); Hadas BAUMER, Tel-Aviv (IL); Sigalit BECHLER, Bney Zion (IL); Shon MENDELSON, Tel Aviv (IL)

(21) Appl. No.: 19/065,341

(22) Filed: Feb. 27, 2025

(51) Int. Cl. G06N 3/096

(52) U.S. Cl. CPC G06N 3/096

(57) ABSTRACT

Aspects of the present disclosure relate to fine-tuning machine learning models based on retrieval augmented generation. Embodiments include generating, using a machine learning model, answers to one or more queries based on a plurality of retrieval augmented generation (RAG) sets comprising documents selected as context data for the one or more queries through a RAG process. Embodiments include generating benchmark scores for the plurality of RAG sets based on the answers. Embodiments include assigning each RAG set of the plurality of RAG sets to one or more groups based on analyzing the benchmark scores. Embodiments include compiling a set of training data for each group in the one or more groups based on the plurality of RAG sets and the assigning. Embodiments include, for each respective group of the one or more groups, training a corresponding machine learning model using the set of training data for the respective group.

### INTRODUCTION

Aspects of the present disclosure relate to techniques for fine-tuning machine learning models based on retrieval augmented generation. In particular, techniques described herein involve using benchmark scores generated for a plurality of retrieval augmented generation (RAG) sets to assign each RAG set to one or more groups, compiling a set of training data for each group, and training a corresponding machine learning model based on the set of training data for each group. Techniques described herein further involve generating an embedding of a query, selecting an expert machine learning model through which to route the query based on comparing the embedding of the query to one or more groups of the RAG sets, and generating an output in response to the query.

### BACKGROUND

Every year, millions of people, businesses, and organizations around the world use software applications to assist with countless aspects of life. The use of machine learning models, including language processing machine learning models, in software applications has become widespread. Because of this, both the amount of input queries and the complexity of input queries provided to, for example, language processing machine learning models have greatly increased. Machine learning models that are not trained (e.g., fine-tuned) for the particular task for which they are used may generate inaccurate and/or inconsistent outputs due to a limited knowledge base. Inaccurate and/or inconsistent outputs may result in providing a user with erroneous results in response to a given input, which may also require the user to run the model again to re-process the input. Such inefficiency may result in significant computational costs and energy consumption associated with language processing machine learning models.

Alternatively, training machine learning models is often costly, with respect to both time and computing resources. Such training may be based on a vast amount of unstructured data that not only takes time and resources to process but also provides a machine learning model with only a most general knowledge base. Additionally, without constant updates, the data becomes nearly immediately outdated. Both of these realities may further result in inaccurate and/or inconsistent outputs generated by the machine learning model as the machine learning model lacks the most relevant and most up-to-date information required to generate optimized outputs.

Thus, there is a need in the art for improved techniques for optimizing machine learning model training and output generation.

### BRIEF SUMMARY

Certain embodiments provide a method of fine-tuning machine learning models based on retrieval augmented generation. The method generally includes: generating, using a machine learning model, answers to one or more queries based on a plurality of retrieval augmented generation (RAG) sets comprising documents selected as context data for the one or more queries through a RAG process; generating benchmark scores for the plurality of RAG sets based on the answers; assigning each RAG set of the plurality of RAG sets to one or more groups based on analyzing the benchmark scores; compiling a set of training data for each group in the one or more groups based on the plurality of RAG sets and the assigning; and for each respective group of the one or more groups, training a corresponding machine learning model using the set of training data for the respective group.

Other embodiments provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of workflow related to fine-tuning machine learning models based on retrieval augmented generation.

FIG. 2 depicts an additional example of workflow related to fine-tuning machine learning models based on retrieval augmented generation.

FIG. 3 depicts an additional example of workflow related to fine-tuning machine learning models based on retrieval augmented generation.

FIG. 4 depicts example operations related to fine-tuning machine learning models based on retrieval augmented generation.

FIG. 5 depicts additional example operations related to fine-tuning machine learning models based on retrieval augmented generation.

FIG. 6 depicts an example of a processing system for fine-tuning machine learning models based on retrieval augmented generation.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for fine-tuning machine learning models based on retrieval augmented generation.

Retrieving relevant context data to provide with a query to a machine learning model may generally be referred to as retrieval augmented generation (RAG). For example, RAG may involve optimizing the output of a machine learning model such as a language processing machine learning model by referencing an authoritative knowledge base outside of training data sources before generating a response. In order to improve output generation in machine learning models, RAG techniques may be used in conjunction with training techniques to fine-tune expert machine learning models to more accurately and efficiently generate refined outputs in response to one or more input queries. Such techniques described herein involve determining the expertise classes of a number of RAG sets (e.g., sets of context data, such as documents, retrieved as part of a RAG process), clustering the RAG sets based on their respective expertise classes into groups, and fine-tuning an expert machine learning model for each group of RAG sets using training data compiled from documents associated with the RAG sets. Once such expert machine learning models are trained, certain embodiments involve routing a query to an optimal expert machine learning model based on comparing an embedding (e.g., vector representation) of the query to the groups, and generating an output in response to the query using the optimal expert machine learning model.

Grouping RAG sets according to expertise may involve the creation of benchmark scores. For example, a machine learning model, such as a language processing machine learning model, may generate answers to one or more queries based on a plurality of RAG sets. The language processing machine learning model may, for instance, be a large language model capable of processing natural language inputs and generating natural language outputs. The RAG sets may comprise documents selected as context data for the one or more queries through a RAG process. Each query may, for example, relate to a particular topic. Based on the answers to the queries, benchmark scores may then be generated for the RAG sets (e.g., where a benchmark score may include a set of scores for set of benchmarks that correspond to a set of topics). The benchmark scores may, for instance, indicate how well each respective RAG set performed across the set of benchmarks (e.g., corresponding to the set of topics), such as based on an accuracy and/or quality of each answer that was generated for each query (e.g., corresponding to a given topic) using the respective RAG set. Additionally, any RAG set with a benchmark score not contained in a range of values may be removed from the plurality of RAG sets. RAG sets with a benchmark score not within the range of values may, for instance, have very little expertise with respect to one or more given topics and/or contain no predominate expertise. For instance, a RAG set that performs consistently well or consistently poorly across a large number of benchmarks (e.g., corresponding to a large number of topics) may not provide much specialized expertise for any particular topic.

Next, each RAG set may be assigned to one or more groups based on the benchmark score for that particular RAG set. For example, a RAG set concerning accounting may be clustered with other similar RAG sets to form an “accounting” grouping (e.g., based on the benchmark score for the RAG set indicating a value within a particular range for a benchmark corresponding to the topic of accounting). A set of training data may then be compiled for each group of the RAG sets. Compiling the set of training data may include aggregating, for each group, all documents in each RAG set contained in that group to produce raw textual data. The raw textual data may then be transformed into natural language training data for machine learning models, such as conversational data or question and answer sets. The set of training data may then be used to train an expert machine learning model for that group. The training may include providing inputs from the set of training data to its corresponding expert machine learning model and iteratively adjusting parameters of the expert machine learning model based on outputs generated by the expert machine learning model in response to inputs (e.g., based on comparing the outputs to labels corresponding to the inputs in the set of training data). In this way, an expert machine learning model is fine-tuned for each group such that an incoming query is processed by the expert machine learning model best suited for the task (i.e., a query can be matched to a group most closely related to that query and an output can be generated more accurately and efficiently by using the corresponding expert machine learning model).

In some cases, techniques further include creating an index for each group, which may include generating an embedding for each document assigned to each group, selecting one or more representative documents in each group and generating an embedding for each of the one or more representative documents, and/or generating a single vector representation of each group.

Once the fine-tuning is completed, a query may be provided to a machine learning model. An embedding may be generated for the query (e.g., by an embedding model) which is then compared to the groups of RAG sets. In one case, the embedding of the query may be compared to embeddings of all the documents contained in the groups and matched to one or more of the documents. In another case, the embedding of the query may be compared to embeddings of representative documents serving as hubs for each group. In yet another case, the embedding of the query may be compared to an embedding of each group. Based on the comparing, an expert model may be selected through which to route the query (i.e., the expert model associated with the group with the highest number of matched documents, the group with one or more of the representative documents with the highest degree of similarity to the query, and/or the group with the highest degree of similarity to the query). For example, a query about a financial document may be matched with a group corresponding to finance and routed to the expert model associated with that group (where such model had been trained specifically on finance related issues based on finance-specific RAG sets). Lastly, the expert machine learning model will generate an output in response to the query.

In some cases, after the output is generated by the model in response to the query, the output may be used to perform additional actions. For example, actions may include displaying the output via a user interface, sending the output to one or more elements of a software application, or a combination thereof.

Embodiments of the present disclosure provide numerous technical and practical effects and benefits. Current techniques for training and generating outputs using machine learning models are costly and often lead to inaccurate and/or inconsistent outputs generated by the machine learning model. The result of such existing techniques is increased computational and energy costs due to implementing said techniques and potentially re-processing erroneous outputs, as well outputs of limited accuracy being generated by machine learning models (e.g., due to being trained on and/or being provided with ambiguous, irrelevant, and/or excessive amounts of information). The present disclosure solves these technical problems. Techniques described herein ensure accurate, more relevant outputs while conserving resources. First, the present disclosure provides techniques for automatically generating sets of training data (e.g., based on RAG sets automatically assigned to a number of groups according to their relative expertise) with which to fine-tune corresponding expert machine learning models. An incoming query may then be compared to the groups to determine which group most closely matches the query, such as based on semantic similarity (e.g., based on embeddings). The expert model corresponding to that most closely related group may then be used to generate an output in response to the query. This improves output accuracy by utilizing an expert machine learning model specifically fine-tuned for a particular subject matter or topic area, ensuring it has the requisite knowledge and proficiency to generate a more complete and precise output. Furthermore, efficiency is likewise improved by fine-tuning the expert models more quickly and with less resources since each expert machine learning model will be fine-tuned on a significantly smaller and more focused training data set (i.e., the expert machine learning model need only be fine-tuned on a specific topic area rather than a large volume of information across countless topic areas). For example, a query regarding a financial document may be matched to a finance group and routed though the corresponding expert machine learning model trained on finance related information, which will efficiently and accurately generate an output since the expert machine learning model is fine-tuned specifically for finance-related issues using financial information, and a vast store of knowledge that does not apply to finance does not need to be consulted (e.g., during fine-tuning or at output generation time, such as in the form of a RAG process that would otherwise have been performed in connection with generating outputs using the trained model). Therefore, techniques described herein may efficiently process and output the correct results in response to a user's query. This results in more accurate and more pertinent results being automatically generated and provided to the user, saving time and resources both in the training and output generation processes (i.e., less data needs be processed while the data itself is also more relevant to the particular query) as well as in avoiding reproducing an alternative output or further processing and/or correcting inaccurate outputs, which would otherwise involve the use of significant computing resources.

### Example Workflows Related to Fine-Tuning Machine Learning Models Based on Retrieval Augmented Generation

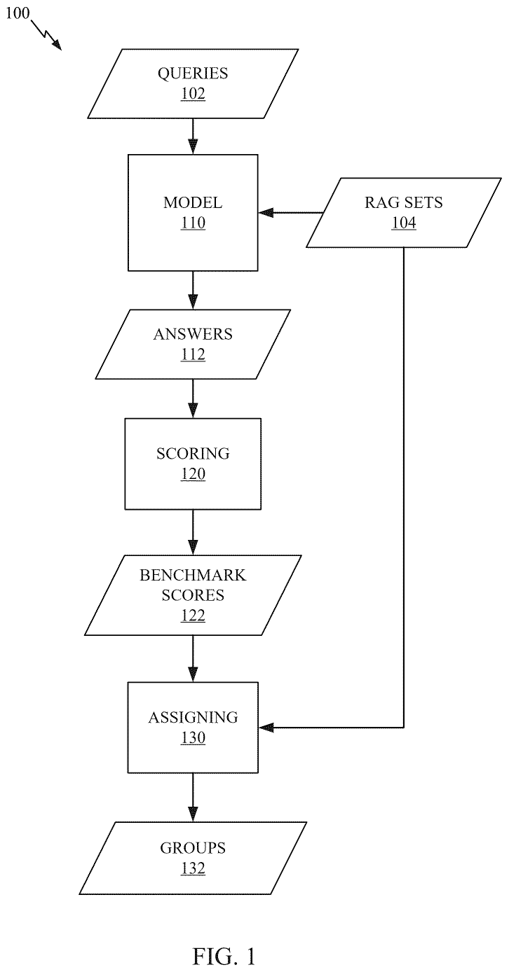

FIG. 1 depicts an example workflow 100 related to fine-tuning machine learning models based on retrieval augmented generation. For example, workflow 100 may represent a first series of steps associated with scoring and clustering a number of retrieval augmented generation (RAG) sets.

A model 110 may comprise a machine learning model. In a particular example, model 110 is a language processing machine learning model such as a large language model (LLM). For example, model 110 may have been trained on a large training data set in order to process natural language inputs and generate natural language content in response. In some embodiments, model 110 is a generative pre-trained transformer (GPT) model that has been trained on a large set of training data (e.g., across a plurality of domains), and is capable as a result of such training to perform a wide variety of language-related tasks in response to natural language prompts. In some embodiments, model 110 has been fine-tuned for one or more particular domains, such as for use with a particular software application or for a specific purpose, while in other embodiments model 110 has been trained in a more general fashion and has not been fine-tuned in such a manner. Model 110 may have a large number of tunable parameters, which are iteratively adjusted during a model training process based on training data. In alternative embodiments, model 110 may be another type of machine learning model that is capable of generating content. For example, model 110 may be a generative adversarial network (GAN), an autoencoder model, an autoregressive model, a diffusion model, a Bayesian network, a hidden Markov model, and/or the like.

The model 110 may receive queries 102, which may contain a series of natural language questions. The model 110 may generate answers 112 in response to the queries 102. The answers 112 may be based on a plurality of RAG sets 104. For example, the RAG sets 104 may comprise documents selected as context data for the queries through a RAG process.

Based on the answers 112, benchmark scores 122 for each of the RAG sets may then be generated during scoring 120. The benchmark scores 122 may be associated with one or more attributes of the RAG sets. For example, each benchmark score may comprise a vector representation, [B₁, B₂, . . . , B_{N}], where each dimension of the vector indicates a proficiency level with a given topic area, subject matter, and/or the like. In a simple case, the benchmark score [1, 0] may be generated for a RAG set, where 1 indicates a very strong proficiency in one topic (e.g., accounting) while 0 indicates a very weak proficiency in another topic (e.g., finance). In a practical example, the benchmark score [0.18, 0.04, 0.97] may be generated, indicating little proficiency in the first two dimensions, and great proficiency in the third dimension. After the benchmark scores are generated, any RAG set with a benchmark score not within a threshold range of values may be excluded from the plurality of RAG sets. For example, a benchmark score with low proficiencies across most or all dimensions (e.g., a score of [0.09, 0.11, 0.08]) will not have the requisite expertise for training an expert model on any topic. On the other hand, a benchmark score with high proficiencies across most or all dimensions (e.g., a score of [0.99, 0.83, 0.92]) will have too varied an information base and could not be effectively used to train an expert model on a single expertise. A benchmark score of [0.01, 0.95, 0.16], for example, is preferred due to its relatively high proficiency in a single topic.

In some embodiments, benchmark scores 122 may be generated based comparing answers 112 to ground truth labels indicating known correct answers (e.g., based on semantic similarity of answers 112 to the ground truth labels, such as based on comparing embeddings of answers 112 to embeddings of the ground truth labels), based on manual review of answers 112 by experts, based on automated evaluation of answers 112 by one or more machine learning models (e.g., using a language processing machine learning model as a judge), and/or the like.

During assigning 130, the remaining RAG sets in the plurality of RAG sets may then be assigned to one or more groups 132 based on the benchmark scores. For example, a group related to accounting may comprise those RAG sets whose benchmark scores indicate a proficiency in accounting (i.e., answers to queries regarding accounting generated using that RAG set were more accurate, more complete, and/or the like compared to answers to the same queries generated using other RAG sets). The groups may be determined, and the RAG sets assigned, using a clustering algorithm such as K-means. K-means clustering may refer to a process by which a number of centroids are created in unlabeled data and each data point is matched to the nearest centroid (e.g., based on a Euclidean distance). Each group of groups 132 may comprise the data points assigned to the corresponding centroid.

In some embodiments, an index may be created for each group. In one example, the index may be created by generating an embedding for each document assigned to each group of the one or more groups, such as by an embedding model. In another example, the index may be created by selecting one or more representative documents in each group of the one or more groups and generating an embedding for each of the one or more representative documents, likewise by an embedding model. Selecting the representative documents may include creating graphs of the documents within each cluster and identifying documents to serve as hubs based on node connections (i.e., such as by utilizing high betweenness centrality or degree centrality). In a final example, the index may be created by generating a single vector representation of each group of the one or more groups, such as by calculating the center of the group. Alternatively, a representation of the group may be generated by creating a summary of the group (e.g., using a language processing machine learning model and/or through one or more other techniques) and using an embedding of the summary as the representation.

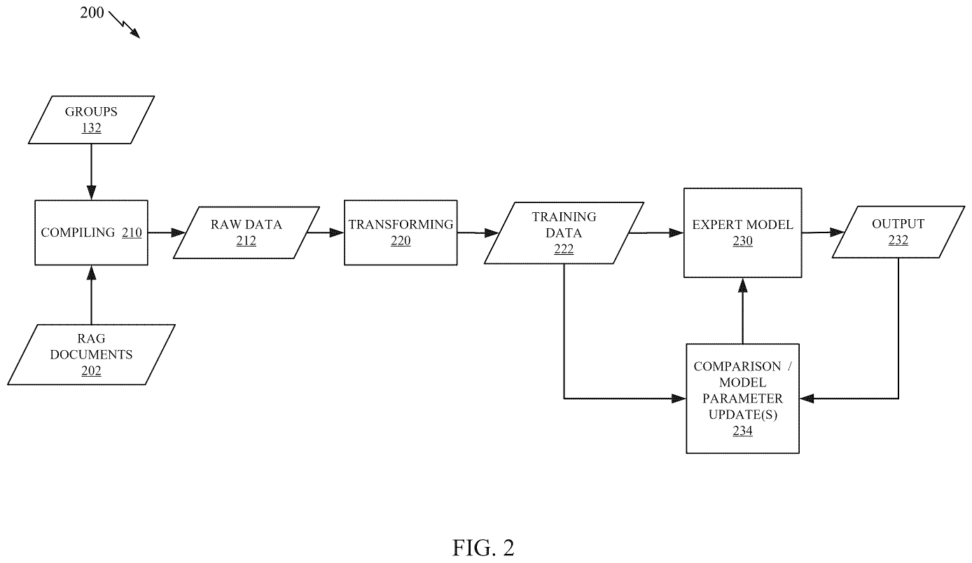

The groups 132 of assigned RAG sets may be utilized in compiling training data to fine-tune expert models, as described in more detail below with respect to FIG. 2.

FIG. 2 depicts an additional example workflow 200 related to fine-tuning machine learning models based on retrieval augmented generation. In particular, FIG. 2 depicts a second series of steps to be performed subsequent to those depicted in FIG. 1, such as fine-tuning expert machine learning models based on the grouped RAG sets.

For each group of groups 132, a set of training data may be compiled. First, during compiling 210, all documents associated with the one or more RAG sets assigned to that particular group may be aggregated into raw data 212. Raw data 212 may comprise raw textual data extracted from the contents of each document in the one or more RAG sets contained in the particular group. Then, during transforming 220, that raw data 212 may be transformed into training data 222 (e.g., by using a data builder). Training data 222 may be natural language training data in conversational form, question and answer form, and/or the like. For example, generating training data 212 may involve prompting a language processing machine learning model to generate training data in a particular form (e.g., natural language questions and answers) based on raw data 212, may involve manual generation, review, and/or editing of training data, and/or the like.

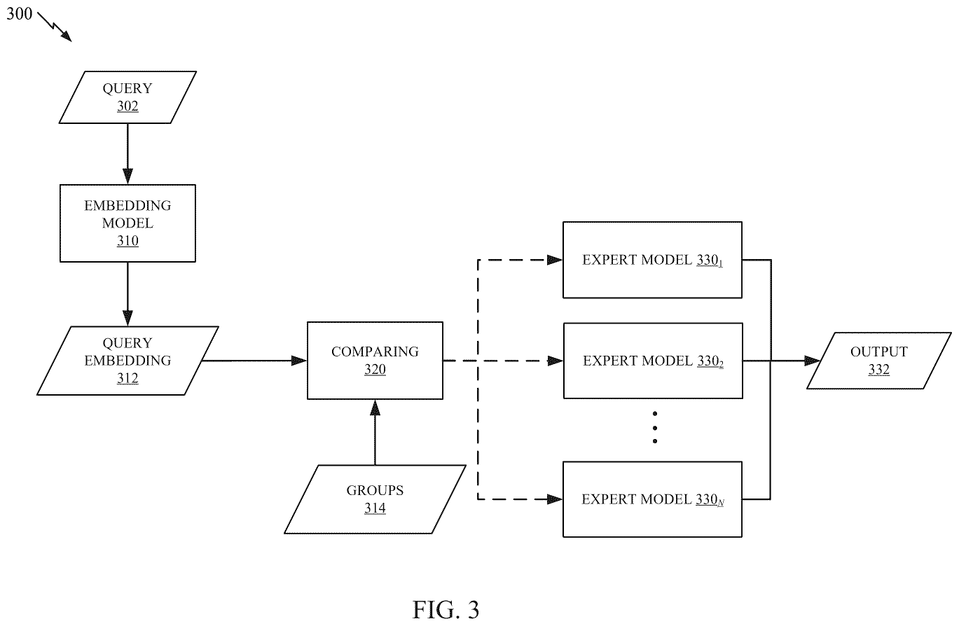

An expert model 230, corresponding to one of the groups of RAG sets, may then be trained using the training data 222. The training may involve a supervised learning process by which training inputs from the training data 222 for the particular group are provided to the corresponding expert model 230, the output 232 generated by the expert model 230 is compared to labels associated with the training inputs in training data 222, and parameters of the expert model 230 are iteratively adjusted based on the comparing, such as during comparison/model parameter updates 234, until one or more conditions are met (e.g., until the output 232 matches the labels, and/or the like). In other embodiments, the training may comprise using direct preference optimization to fine-tune each model, such as based on user feedback. In this way, an expert model is specifically fine-tuned for each group of topic areas, ensuring that more accurate, complete, and efficient results are generated when a query is received and processed as described in more detail below with respect to FIG. 3.

In order to remain optimized, the expert models may be continuously fine-tuned. For example, one or more expert models may be updated when a new RAG set is received. When the new RAG set is received, it may be matched to the group most closely related to the RAG set, such as by using the clustering method(s) described above. If a distance to that group exceeds a given threshold value (i.e., the new RAG set does not meet a certain measure of relatedness to the existing group), a new group may be created with an associated expert model subsequently trained using the fine-tuning process above. If the distance does not exceed the threshold value, the RAG set may be added to the existing group, the training data for that group may be updated with the documents in the new RAG set, and the expert model may be re-trained using the updated set of training data. The expert models therefore remain up-to-date with the most current and complete information, increasing the accuracy and efficiency of output generation by the expert models.

FIG. 3 depicts an additional example workflow 300 related to fine-tuning machine learning models based on retrieval augmented generation. In particular, FIG. 3 depicts an inference phase to be performed subsequent to those steps depicted in FIG. 1 and FIG. 2, such as generating outputs in response to queries routed through the fine-tuned expert machine learning models.

An embedding model 310 may receive a query 302 and generate a query embedding 312 of the query 302. An embedding generally refers to a vector representation of an entity (e.g., a document) that represents the entity as a vector in n-dimensional space such that similar entities are represented by vectors that are close to one another in the n-dimensional space. Embeddings may be generated through the use of an embedding model, such as a neural network or other type of machine learning model that learns a representation (embedding) for an entity through a training process that trains the neural network based on a data set, such as a plurality of features of a plurality of entities. In one example, an embedding model used to generate embeddings comprises a Bidirectional Encoder Representations from Transformer (BERT) model, which involves the use of masked language modeling to determine embeddings. In a particular example, the embedding model comprises a Sentence-BERT model. In other embodiments, the embedding model may involve embedding techniques such as Word2Vec and GloVe embeddings. These are included as examples, and other techniques for generating embeddings are possible.

The query embedding 312 may then be compared to groups 314 during comparing 320. Comparing 320 may comprise one or more processes based on the method by which the groups were indexed. For example, in some embodiments, the query embedding 312 may be compared to an embedding of each document in each group of the groups 314. The query 302 may then be matched to one or more documents (e.g., by returning the K nearest documents in a Faiss search). In other embodiments, the query embedding 312 may be compared to embeddings of the one or more representative documents in each group of the groups 314. In certain other embodiments, the query embedding 312 may be compared to an embedding of each of the one or groups.

Based on the comparing 230, the query 302 is then routed to the expert model most well suited to process the query 302. For example, the expert model most well suited to process the query 302 may be the expert model associated with the group that contains the highest number of matches between the query 302 and corresponding documents contained in the group (e.g., out of 4 matches, 3 were in that particular group), the expert model associated with the group with a representative document having a highest degree of similarity to the query 302 (e.g., determined using cosine similarity), or the expert model associated with the group having the highest degree of similarity to the query 302. The expert model, for instance, may be an LLM, a generative adversarial network (GAN), an autoencoder model, an autoregressive model, a diffusion model, a Bayesian network, a hidden Markov model, and/or the like.

In one example, if a query is received concerning a finance issue, it may be matched to the group whose subject matter pertains to finance and routed to the corresponding expert machine learning model (e.g., expert model 330₂) which has been trained using documents from finance-specific RAG sets. The expert model, expert model 330₂ in this example, may then generate the output 332 in response to the query 302. Consequently, the expert model has been trained based on more tailored information with which to generate the output, resulting in improved accuracy of results in addition to faster results that utilize fewer computing resources than would be required in alternative techniques, such as those involving a model that has not been fine-tuned and that is provided with additional contextual data retrieved through a RAG process. Additionally, the matching and routing may be done automatically, without the need for human input, further increasing the efficiency of the process. In some embodiments, further action may be performed based on the output, such as displaying the output via a user interface or sending the output to one or more elements of a software application.

### Example Operations Related to Fine-Tuning Machine Learning Models Based on Retrieval Augmented Generation

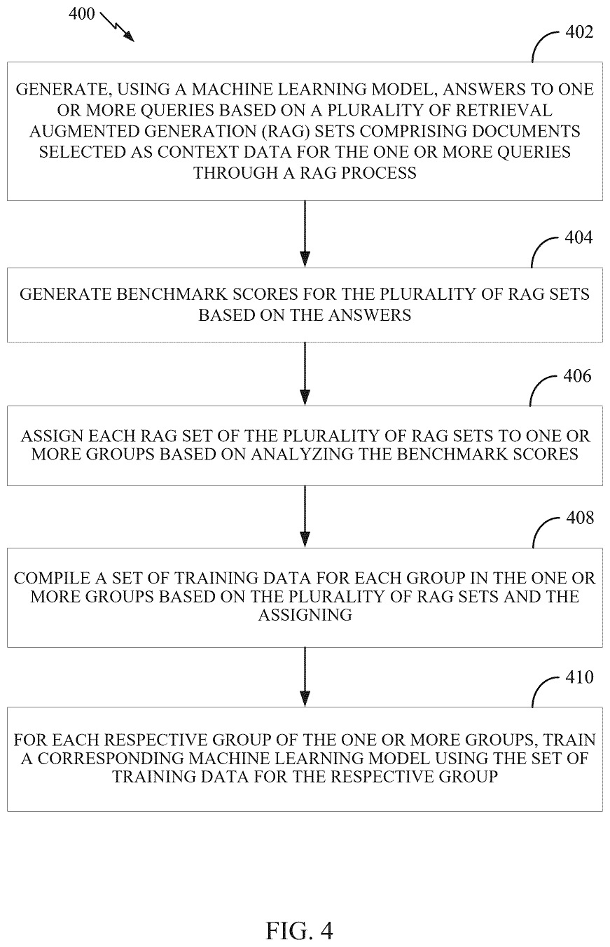

FIG. 4 depicts example operations 400 related to fine-tuning machine learning models based on retrieval augmented generation. For example, operations 400 may be performed by one or more of the components described with respect to FIG. 1 and/or FIG. 2.

Operations 400 begin at step 402 with generating, using a machine learning model, answers to one or more queries based on a plurality of retrieval augmented generation (RAG) sets comprising documents selected as context data for the one or more queries through a RAG process.

Operations 400 continue at step 404 with generating benchmark scores for the plurality of RAG sets based on the answers. Some embodiments provide that the generating of the benchmark scores for the plurality of RAG sets further comprises excluding from the one or more RAG sets any RAG set with a benchmark score not contained in a range of values. In other embodiments, the benchmark scores comprise one or more expertise levels associated with each RAG set of the plurality of RAG sets

Operations 400 continue at step 406 with assigning each RAG set of the plurality of RAG sets to one or more groups based on analyzing the benchmark scores. In some embodiments, the assigning of each RAG set of the plurality of RAG sets to the one or more groups based on analyzing the benchmark scores is performed using a clustering algorithm.

Operations 400 continue at step 408 with compiling a set of training data for each group in the one or more groups based on the plurality of RAG sets and the assigning. According to certain embodiments, the compiling of the set of training data for each group in the one or more groups based on the plurality of RAG sets and the assigning comprises aggregating, for each respective group in the one or more groups, all documents in each RAG set of the plurality of RAG sets that is contained in the respective group to produce raw textual data; and transforming the raw textual data into natural language training data for machine learning models.

Operations 400 continue at step 410 with, for each respective group of the one or more groups, training a corresponding machine learning model using the set of training data for the respective group. In some embodiments, the training of the corresponding machine learning model for each respective group of the one or more groups comprises providing, to the corresponding machine learning model, the set of training data for the respective group and iteratively adjusting parameters of the corresponding machine learning model based on an output generated by the corresponding machine learning model in response to the set of training data for the respective group.

In certain embodiments, the method further comprises creating an index for each group of the one or more groups, wherein the creating of the index for each group of the one or more groups comprises one or more of: generating an embedding for each document assigned to each group of the one or more groups; selecting one or more representative documents in each group of the one or more groups and generating an embedding for each of the one or more representative documents; or generating a single vector representation of each group of the one or more groups. According to other embodiments, the method further comprises, for each additional RAG set, identifying a group of the one or more groups most closely related to the additional RAG set, determining a distance between the additional RAG set and the identified group, and or more of: if the distance exceeds a threshold value, generating a new group containing the additional RAG set, compiling a set of training data for the new group based on the additional RAG set, and training a corresponding machine learning model using the set of training data for the new group; or if the distance does not exceed a threshold value, assigning the additional RAG set to the identified group, compiling an updated set of training data based on RAG sets assigned to the identified group, and training the machine learning model corresponding to the identified group based on the updated set of training data.

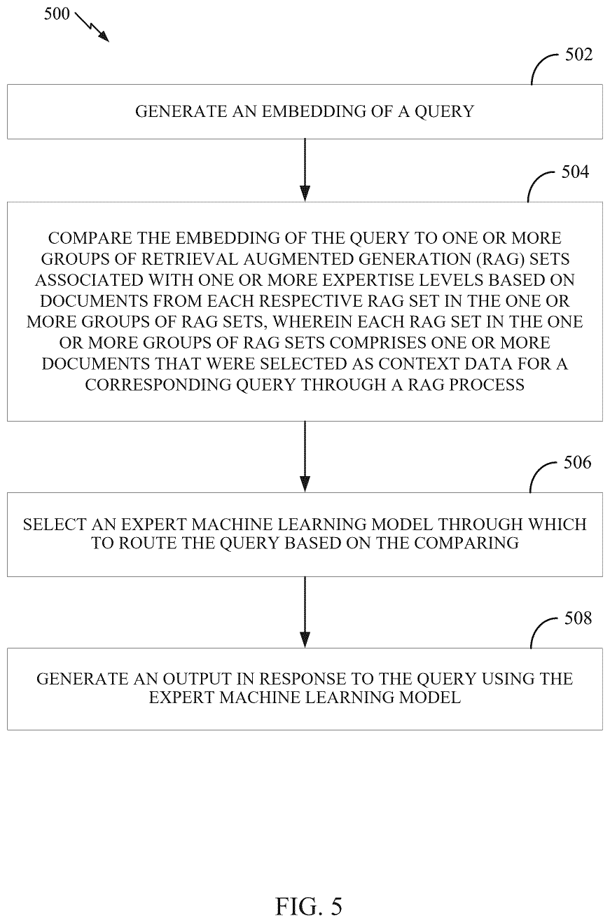

FIG. 5 depicts additional example operations 500 related to fine-tuning machine learning models based on retrieval augmented generation. For example, operations 500 may be performed by one or more of the components described with respect to FIG. 3.

Operations 500 begin at step 502 with generating an embedding of a query.

Operations 500 continue at step 504 with comparing the embedding of the query to one or more groups of retrieval augmented generation (RAG) sets associated with one or more expertise levels based on documents from each respective RAG set in the one or more groups of RAG sets, wherein each RAG set in the one or more groups of RAG sets comprises one or more documents that were selected as context data for a corresponding query through a RAG process. According to some embodiments, the comparing of the embedding of the query to the one or more groups of RAG sets associated with the one or more expertise levels based on documents from each respective RAG set in the one or more groups of RAG sets comprises one or more of: comparing the embedding of the query to an embedding of each document in each group of the one or more groups, matching the query to one or more documents, and determining a group of the one or more groups that contains a highest number of matches between the query and corresponding documents contained in the group; comparing the embedding of the query to embeddings of one or more representative documents in each group of the one or more groups and determining a particular group of the one or more groups with a representative document having a highest degree of similarity to the query; or comparing the embedding of the query to an embedding of each of the one or groups and determining a given group of the one or more groups with a highest degree of similarity to the query.

Operations 500 continue at step 506 with selecting an expert machine learning model through which to route the query based on the comparing. Certain embodiments provide that the selecting of the expert machine learning model through which to route the query based on the comparing is performed automatically by a machine learning model.

Operations 500 continue at step 508 with generating an output in response to the query using the expert machine learning model.

In certain embodiments, the method further comprises performing an action based on the output, wherein the performing of the action comprises one or more of: displaying the output via a user interface; or sending the output to one or more elements of a software application.

### Example of a Processing System for Fine-Tuning Machine Learning Models Based on Retrieval Augmented Generation

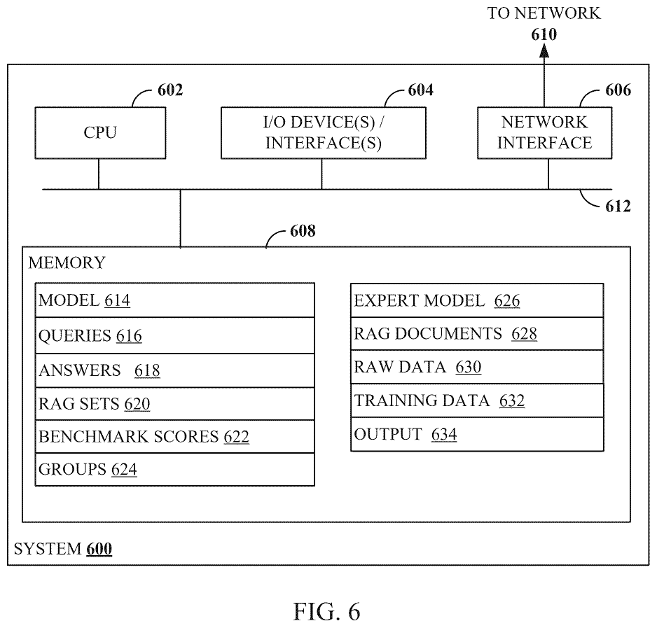

FIG. 6 illustrates an example system 600 with which embodiments of the present disclosure may be implemented. For example, system 600 may be configured to perform operations 400 of FIG. 4 or operations 500 FIG. 5 and/or to implement one or more components as in FIG. 1, FIG. 2, or FIG. 3.

System 600 includes a central processing unit (CPU) 602, one or more I/O device interfaces that may allow for the connection of various I/O devices 604 (e.g., keyboards, displays, mouse devices, pen input, etc.) to the system 600, network interface 606, a memory 608, and an interconnect 612. It is contemplated that one or more components of system 600 may be located remotely and accessed via a network 610. It is further contemplated that one or more components of system 600 may comprise physical components or virtualized components.

CPU 602 may retrieve and execute programming instructions stored in the memory 608. Similarly, the CPU 602 may retrieve and store application data residing in the memory 608. The interconnect 612 transmits programming instructions and application data, among the CPU 602, I/O device interface 604, network interface 606, and memory 608. CPU 602 is included to be representative of a single CPU, multiple CPUs, a single CPU having multiple processing cores, and other arrangements.

Additionally, the memory 608 is included to be representative of a random access memory or the like. In some embodiments, memory 608 may comprise a disk drive, solid state drive, or a collection of storage devices distributed across multiple storage systems. Although shown as a single unit, the memory 608 may be a combination of fixed and/or removable storage devices, such as fixed disc drives, removable memory cards or optical storage, network attached storage (NAS), or a storage area-network (SAN).

As shown, memory 608 includes model 614, queries 616, answers 618, RAG sets 620, benchmark scores 622, and groups 624. Model 614 may be representative of model 110 of FIG. 1. Queries 616 may be representative of queries 102 of FIG. 1. Answers 618 may be representative of answers 112 of FIG. 1. RAG sets 620 may be representative of RAG sets 104 of FIG. 1. Benchmark scores 622 may be representative of benchmark scores 122 of FIG. 1. Groups 624 may be representative of groups 132 of FIG. 1 and FIG. 2.

Memory 608 further comprises expert model 626 which may correspond to expert model 230 of FIG. 2. Memory 608 further comprises RAG documents 628, which may correspond to RAG documents 202 of FIG. 2. Memory 608 further comprises raw data 630, which may correspond to raw data 212 of FIG. 2. Memory 608 further comprises training data 632, which may correspond to training data 222 of FIG. 2. Memory 608 further comprises output 634, which may correspond to output 232 of FIG. 2. It is noted that in some embodiments, system 600 may interact with one or more external components, such as via network 610, in order to retrieve data and/or perform operations. Furthermore, techniques described herein may be implemented via more or fewer components than those shown and described with respect to FIG. 6, such as on one or more computing systems.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for fine-tuning machine learning models based on retrieval augmented generation, comprising:
generating, using a machine learning model, answers to one or more queries based on a plurality of retrieval augmented generation (RAG) sets comprising documents selected as context data for the one or more queries through a RAG process;
generating benchmark scores for the plurality of RAG sets based on the answers;
assigning each RAG set of the plurality of RAG sets to one or more groups based on analyzing the benchmark scores;
compiling a set of training data for each group in the one or more groups based on the plurality of RAG sets and the assigning; and
for each respective group of the one or more groups, training a corresponding machine learning model using the set of training data for the respective group.

2. The method of claim 1, wherein the generating of the benchmark scores for the plurality of RAG sets further comprises excluding from the one or more RAG sets any RAG set with a benchmark score not contained in a range of values.

3. The method of claim 1, further comprising creating an index for each group of the one or more groups, wherein the creating of the index for each group of the one or more groups comprises one or more of:
generating an embedding for each document assigned to each group of the one or more groups;
selecting one or more representative documents in each group of the one or more groups and generating an embedding for each of the one or more representative documents; or
generating a single vector representation of each group of the one or more groups.

4. The method of claim 1, wherein the compiling of the set of training data for each group in the one or more groups based on the plurality of RAG sets and the assigning comprises:
aggregating, for each respective group in the one or more groups, all documents in each RAG set of the plurality of RAG sets that is contained in the respective group to produce raw textual data; and
transforming the raw textual data into natural language training data for machine learning models.

5. The method of claim 1, wherein the training of the corresponding machine learning model for each respective group of the one or more groups comprises providing, to the corresponding machine learning model, the set of training data for the respective group and iteratively adjusting parameters of the corresponding machine learning model based on an output generated by the corresponding machine learning model in response to the set of training data for the respective group.

6. The method of claim 1, wherein the benchmark scores comprise one or more expertise levels associated with each RAG set of the plurality of RAG sets.

7. The method of claim 1, wherein the assigning of each RAG set of the plurality of RAG sets to the one or more groups based on analyzing the benchmark scores is performed using a clustering algorithm.

8. The method of claim 1, further comprising, for each additional RAG set, identifying a group of the one or more groups most closely related to the additional RAG set, determining a distance between the additional RAG set and the identified group, and or more of:
if the distance exceeds a threshold value, generating a new group containing the additional RAG set, compiling a set of training data for the new group based on the additional RAG set, and training a corresponding machine learning model using the set of training data for the new group; or
if the distance does not exceed a threshold value, assigning the additional RAG set to the identified group, compiling an updated set of training data based on RAG sets assigned to the identified group, and training the machine learning model corresponding to the identified group based on the updated set of training data.

9. A method for fine-tuning machine learning models based on retrieval augmented generation, comprising:
generating an embedding of a query;
comparing the embedding of the query to one or more groups of retrieval augmented generation (RAG) sets associated with one or more expertise levels based on documents from each respective RAG set in the one or more groups of RAG sets, wherein each RAG set in the one or more groups of RAG sets comprises one or more documents that were selected as context data for a corresponding query through a RAG process;
selecting an expert machine learning model through which to route the query based on the comparing; and
generating an output in response to the query using the expert machine learning model.

10. The method of claim 9, wherein the comparing of the embedding of the query to the one or more groups of RAG sets associated with the one or more expertise levels based on documents from each respective RAG set in the one or more groups of RAG sets comprises one or more of:
comparing the embedding of the query to an embedding of each document in each group of the one or more groups, matching the query to one or more documents, and determining a group of the one or more groups that contains a highest number of matches between the query and corresponding documents contained in the group;
comparing the embedding of the query to embeddings of one or more representative documents in each group of the one or more groups and determining a particular group of the one or more groups with a representative document having a highest degree of similarity to the query; or
comparing the embedding of the query to an embedding of each of the one or groups and determining a given group of the one or more groups with a highest degree of similarity to the query.

11. The method of claim 9, further comprising performing an action based on the output, wherein the performing of the action comprises one or more of:
displaying the output via a user interface; or
sending the output to one or more elements of a software application.

12. The method of claim 9, wherein the selecting of the expert machine learning model through which to route the query based on the comparing is performed automatically by a machine learning model.

13. A system for fine-tuning machine learning models based on retrieval augmented generation, comprising:
one or more processors; and
a memory comprising instructions that, when executed by the one or more processors, cause the system to:
generate, using a machine learning model, answers to one or more queries based on a plurality of retrieval augmented generation (RAG) sets comprising documents selected as context data for the one or more queries through a RAG process;
generate benchmark scores for the plurality of RAG sets based on the answers;
assign each RAG set of the plurality of RAG sets to one or more groups based on analyzing the benchmark scores;
compile a set of training data for each group in the one or more groups based on the plurality of RAG sets and the assigning; and
for each respective group of the one or more groups, training a corresponding machine learning model using the set of training data for the respective group.

14. The system of claim 13, wherein the generating of the benchmark scores for the plurality of RAG sets further comprises excluding from the one or more RAG sets any RAG set with a benchmark score not contained in a range of values.

15. The system of claim 13, wherein the instructions, when executed by the one or more processors, further cause the system to:
create an index for each group of the one or more groups, wherein the creating of the index for each group of the one or more groups comprises one or more of:
generating an embedding for each document assigned to each group of the one or more groups;
selecting one or more representative documents in each group of the one or more groups and generating an embedding for each of the one or more representative documents; or
generating a single vector representation of each group of the one or more groups.

16. The system of claim 13, wherein the compiling of the set of training data for each group in the one or more groups based on the plurality of RAG sets and the assigning comprises:
aggregating, for each respective group in the one or more groups, all documents in each RAG set of the plurality of RAG sets that is contained in the respective group to produce raw textual data; and
transforming the raw textual data into natural language training data for machine learning models.

17. The system of claim 13, wherein the training of the corresponding machine learning model for each respective group of the one or more groups comprises providing, to the corresponding machine learning model, the set of training data for the respective group and iteratively adjusting parameters of the corresponding machine learning model based on an output generated by the corresponding machine learning model in response to the set of training data for the respective group.

18. The system of claim 13, wherein the benchmark scores comprise one or more expertise levels associated with each RAG set of the plurality of RAG sets.

19. The system of claim 13, wherein the assigning of each RAG set of the plurality of RAG sets to the one or more groups based on analyzing the benchmark scores is performed using a clustering algorithm.

20. The system of claim 13, wherein the instructions, when executed by the one or more processors, further cause the system to, for each additional RAG set, identify a group of the one or more groups most closely related to the additional RAG set, determine a distance between the additional RAG set and the identified group, and or more of:
if the distance exceeds a threshold value, generate a new group containing the additional RAG set, compile a set of training data for the new group based on the additional RAG set, and train a corresponding machine learning model using the set of training data for the new group; or
if the distance does not exceed a threshold value, assign the additional RAG set to the identified group, compile an updated set of training data based on RAG sets assigned to the identified group, and train the machine learning model corresponding to the identified group based on the updated set of training data.
